(19) United States
(12) Patent Application Publication
(10) Pub. No.: US 2012/0033078 A1
(43) Pub. Date: Feb. 9, 2012

(54) HANDLING ASSISTANT APPARATUS FOR TWO-BODY CONNECTED VEHICLE

(75) Inventor: Hanzhi Huang, Changhai (CN)

(73) Assignee: DELPHI TECHNOLOGIES, INC., TROY, MI (US)

(21) Appl. No.: 13/255,181

(22) PCT Filed: Mar. 30, 2010
(86) PCT No.: PCT/US10/29122

§ 371 Date: Sep. 7, 2011

(30) Foreign Application Priority Data
Mar. 30, 2009 (CN) 200920008223.7

(51) Int. Cl. H04N 7/18

(52) U.S. Cl. 348/148; 348/E07.085

(57) ABSTRACT

A handling assistant apparatus for two-body connected vehicle is disclosed. The apparatus is applied to a two-body connected vehicle including a tractor and a trailer, the tractor and the trailer having different turn radius. A static signal acquisition means acquires static signals of the tractor and the trailer. A moving orientation signal acquisition means acquires moving orientation signals of the tractor and the trailer. A video signal acquisition means acquires original video signals. An angle acquisition means is mounted at the joint point of the tractor and the trailer and acquires an angle signal between the moving orientations of the tractor and the trailer. A dynamic signal generation means generates dynamic signals of the tractor and the trailer based on the original video signals, the static signals, the moving orientation signals and the angle signal. The dynamic signal reflects a prediction of the moving orientation and a position of the tractor and the trailer. A dynamic signal presentation means presents the dynamic signal.

### CROSS REFERENCE TO RELATED APPLICATIONS

This application claims the benefit under 35 U.S.C. §371 of PCT Patent Application Number PCT/US2010/29122, filed Mar. 30, 2010, and China Utility Application No. 200920008223.7, filed Mar. 30, 2009, the entire disclosure of which is hereby incorporated herein by reference. Furthermore, related application PCT/US10/28383, filed 24 Mar. 2010 is incorporated herein by reference.

### FIELD OF THE INVENTION

The present disclosure relates to automobile parts, more particularly, relates to handling assistant apparatus for two-body connected vehicle.

### BACKGROUND

The term two-body connected or articulated vehicle generally refers to Tractor—Trailer vehicles, which often have a large length more than 10 meters. A two-body connected vehicle is composed of a tractor and a trailer. Operation of a two-body connected vehicle is difficult, especially during reversing and parking the vehicle. The tractor and the trailer are connected through a rotatable joint and often have different turning radiuses, so the tractor and the trailer will have different moving tracks when reversing with turning. A driver can only operate the tractor. The moving orientation of the tractor is predictable and operable by the driver. However, the trailer can not be directly operated and the moving orientation can not be predicted by the driver. Crash or scrape accidents may happen on the trailer.

Backward vision cameras are used to facilitate the reversing of the vehicle. Backward vision cameras are widely used on signal-body vehicles and are proved to be successful. However, backward vision cameras have not obtained the expected effects on two-body connected vehicles. The difference between a two-body connected vehicle and a single-body vehicle is: the single-body vehicle has a single turning and moving track because it only has one body, the driver may predict the moving orientation of the vehicle through the backward camera and may adjust the moving orientation through operation of the vehicle. However, for a two-body connected vehicle, the tractor and the trailer have different turning or moving tracks, the observed moving orientation through the backward camera is the moving orientation of the trailer, not the tractor. On the other hand, only the tractor can be operated and only the moving orientation of the tractor can be directly adjusted. Therefore, what is observed by the driver is not directly corresponding to his operation, the operation of the driver can not be directly reflected on the change of the moving orientation of the trailer. Accidents may happen under such a condition.

### SUMMARY

Embodiments of the present disclosure provide an apparatus which may intuitively reflect the relationship between the driver's operation and the moving track of the trailer.

According to an embodiment, a handling assistant apparatus for two-body connected vehicle is provided. The apparatus is applied to a two-body connected vehicle including a tractor and a trailer, the tractor and the trailer each having a different turn radius. A static signal acquisition means acquires static signals of the tractor and the trailer. The static signals include length signals of the tractor and the trailer and minimum turning radius signals of the tractor and the trailer. A moving orientation signal acquisition means acquires moving orientation signals of the tractor and the trailer. A video signal acquisition means acquires original video signals. An angle acquisition means is mounted at the joint point of the tractor and the trailer and acquires an angle signal between the moving orientations of the tractor and the trailer. A dynamic signal generation means generates dynamic signals of the tractor and the trailer based on the original video signals, the static signals of the tractor and the trailer, the moving orientation signals of the tractor and the trailer and the angle signal between the moving orientations of the tractor and the trailer. The dynamic signal reflects a prediction of the moving orientation and a position of the tractor and the trailer. A dynamic signal presentation means presents the dynamic signal.

According to an embodiment, the video signal acquisition means is a backward vision camera inclined at the top of the rear of the trailer.

According to an embodiment, the dynamic signal presentation means includes a video signal presentation means and a dynamic signal rendering means. The dynamic signal presentation means presents video signals acquired by the backward vision camera. The dynamic signal rendering means presents a prediction of the moving orientation and the position of the tractor and the trailer, converts the prediction from a real world coordinate to a pixel coordinate, and renders predicted lines indicative of the predicted moving orientation and position upon the video signals presented by the video signal presentation means.

The handling assistant apparatus for two-body connected vehicle may intuitively reflect the relationship between the driver's operation and the moving track of the trailer by rendering predicted lines. The accuracy of operation is raised and the possibility of accidents such as crash or scrape is reduced.

### BRIEF DESCRIPTION OF THE DRAWINGS

The above or other features, natures or advantages of the present disclosure will be more obvious to the skilled person in the art by the following descriptions of the embodiments accompanying with the drawings, the same sign reference indicates the identical features throughout the description, and wherein:

FIG. 1 illustrates a structural diagram of a handling assistant apparatus for two-body connected vehicle according to an embodiment of the present disclosure;

FIG. 2 illustrates a structural diagram of a static signal acquisition means according to an embodiment of the present disclosure;

FIG. 3 illustrates an exemplary static signal according to an embodiment of the present disclosure;

FIG. 4 illustrates a structural diagram of a dynamic signal generation means according to an embodiment of the present disclosure;

FIG. 5 illustrates an exemplary dynamic signal according to an embodiment of the present disclosure;

FIG. 6 illustrates a schematic prediction of moving orientation and position according to an embodiment of the present disclosure;

FIG. 7 illustrates a structural diagram of a dynamic signal presentation means according to an embodiment of the present disclosure;

FIG. 8 illustrates a schematic view of presentation of a dynamic signal according to an embodiment of the present disclosure.

### DETAILED DESCRIPTION

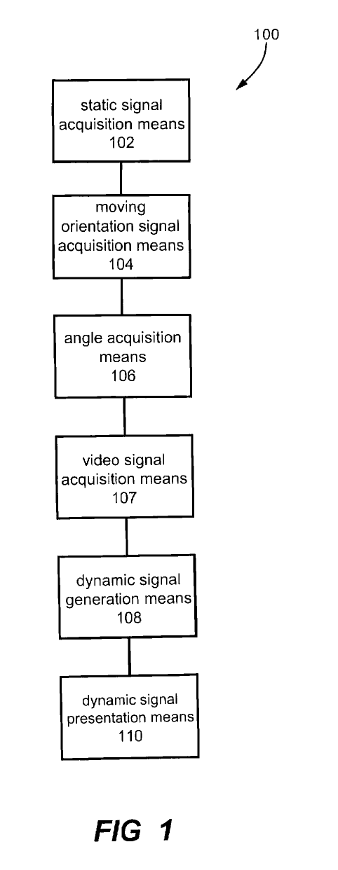

As shown in FIG. 1, a handling assistant apparatus 100 for two-body connected vehicle is disclosed. The handling assistant apparatus 100 includes: a static signal acquisition means 102, a moving orientation signal acquisition means 104, an angle acquisition means 106, a video signal acquisition means 107, a dynamic signal generation means or controller 108 and a dynamic signal presentation means 110.

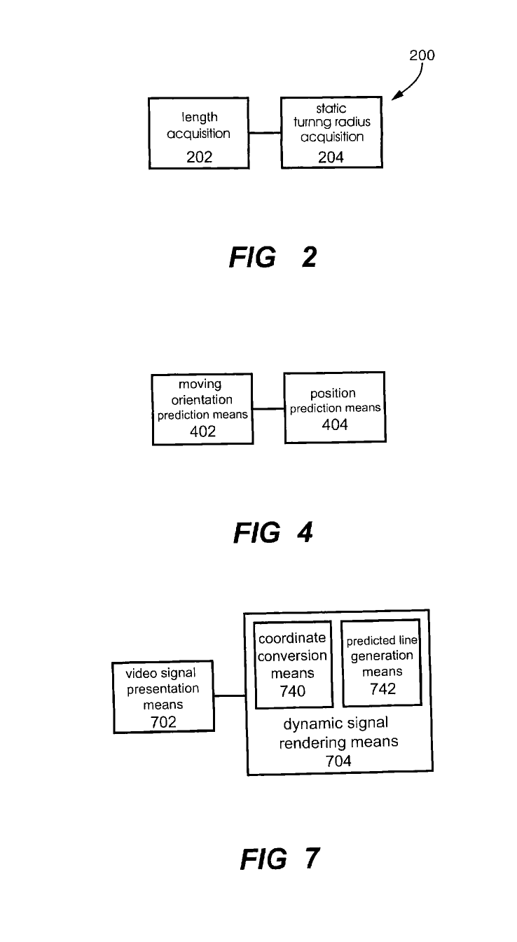

The static signal acquisition means 102 acquires static signals of the tractor and the trailer. The static signals include length signals of the tractor and the trailer and minimum turning radius signals of the tractor and the trailer. As shown in FIG. 2, according to an embodiment, the length signals 200 of the tractor and the trailer are acquired by a length acquisition means 202, and the minimum turning radius signals of the tractor and the trailer are acquired by a static turning radius acquisition means 204.

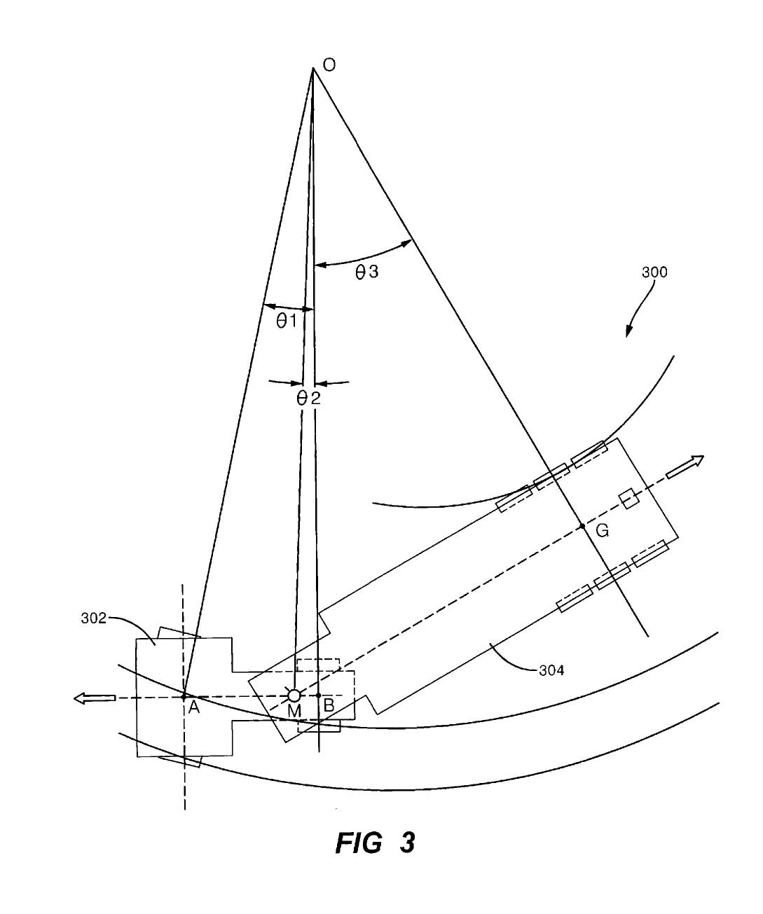

According to an embodiment, more static signals may be acquired, as shown in FIG. 3. FIG. 3 illustrates a two-body connected vehicle or articulated tractor trailer 300.

Wherein,

OA is the minimum turning radius of the tractor;

Point A is the middle point of the front axle of the tractor;

Point O is the assumed center point of the turn circle, Point O is the center point for the turn circle of both the tractor and the trailer;

Point M is the joint point or rotation axis of the tractor and the trailer;

Point B is the middle point of rear axle of the tractor;

Point G′ is the middle point of the rear bridge of the trailer (it is assumed that the trailer turns by the minimum turning radius);

OG′ is the minimum turning radius of the trailer along a turn circle centered by point O.

Then,

OG′=\sqrt{OA²−AB²+MB²−MG²}.

In FIG. 3, the angle between OA and OB is denoted as θ1, the angle between OM and OB is denoted as θ2, the angle between OM and OG′ is denoted as θ3.

It is assumed that the tractor 302 moves along line AB and the trailer 304 moves along line MG′. The moving orientation signal acquisition means 104 acquires moving orientation signals of the tractor and the trailer, that is the orientation of line AB and the orientation of line MG′ (it is assumed that the trailer turns by the minimum turning radius OG′).

The angle acquisition means 106 acquires an angle signal between the moving orientations of the tractor and the trailer. FIG. 3 shows the condition that both the tractor and the trailer turn by their minimum turning radiuses. However, in an actual condition, it is impossible that the vehicle directly enters into such a condition (directly turns by the minimum turning radius). For example, when the tractor and the trailer are initially along a straight line, the tractor and the trailer can not enter a condition that turn by the minimum radius immediately even the driver turns the steering wheel to a maximum position, it need a period of time for the tractor and the trailer to enter the condition shown in FIG. 3. During the above period, since the tractor is directly operated by the driver, it may enter into the condition that turns by the minimum radius quickly. However, the trailer can not enter into the condition that turns by the minimum radius so quickly. The trailer will gradually increase its turning angle and gradually enter into the condition that turns by the minimum radius. During this period, the moving track of the trailer is not strictly along a circle having a radius of OG′ (shown in FIG. 3), the moving track is an arc. For accurate prediction of this arc, the angle between the actual moving orientation of the tractor and the actual moving orientation of the trailer is utilized, the angle is shown as the angle between AB and MG′ in FIG. 3. The angle is measured by the angle acquisition means 106 in real time. The angle acquisition means 106 is mounted at the joint point of the tractor and the trailer, as denoted by point M in FIG. 3. The angle acquisition means may be a Hall sensor.

As described above, when the tractor and the trailer are along a straight line, or the tractor and the trailer both turn by their minimum turning radius, the moving tracks of the tractor and the trailer are fixed. However, during the period mentioned above, the trailer gradually enters into the condition that turns by its minimum turning radius from the initial status. During this period, the turning radius of the trailer is changing and shall be regarded as a dynamic turning radius. The dynamic signal generation means 108 predicts the moving track of the trailer during this period. The dynamic signal generation means 108 generate dynamic signals of the tractor and the trailer based on the original video signals acquired by the video signal acquisition means 107, the static signals acquired by the static signal acquisition means 102, the moving orientation signals acquired by the moving orientation signal acquisition means 104 and the angle signal acquired by the angle acquisition means 106. The video signal acquisition means 107 may be implemented by a backward camera inclined at a particular height of the rear of the trailer, the acquired original video signals are video images behind the trailer.

According to an embodiment, the dynamic signal generation means 108 a moving orientation prediction means 402 and a position prediction means 404. The moving orientation prediction means 402 generates moving orientation prediction signals of the tractor and the trailer based on the static signals, the moving orientation signals and the angle signal. The position prediction means 404 generates position prediction signals of the tractor and the trailer based on the static signals, the moving orientation signals and the angle signal.

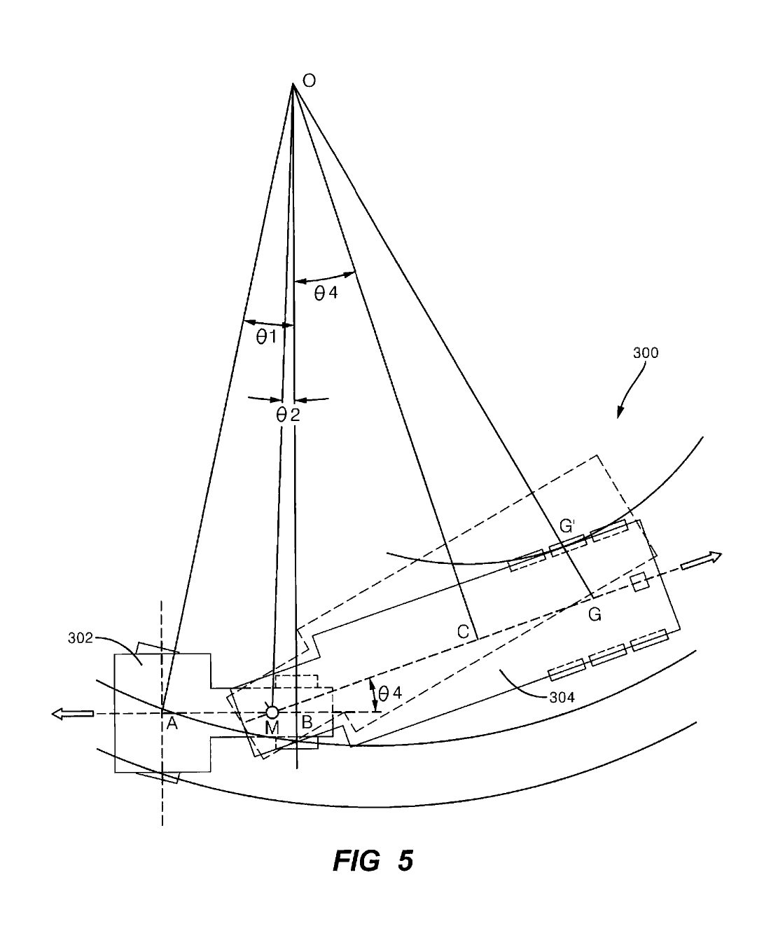

According to an embodiment, more static signals may be acquired, as shown in FIG. 5.

θ4 is an angle between the actual moving orientation of the tractor and the actual moving orientation of the trailer. The actual turning radius of the trailer is OG, not the minimum turning radius, because the trailer does not immediately turn by its minimum turning radius. In FIG. 4, θ4 is the angle between AB and MG.

Point C is a joint point of MG and a vertical line from point O to MG, OC is perpendicular to MG, so the angle between OM and OC is θ4;

Then,

OM=\sqrt{MB²+OA²−AB²};

MC=OM×sin θ4;

OC=OM×cos θ4;

CG=MG−MC;

$$Further , \\ OG = \sqrt{\begin{matrix}( {MB}^{2} + {OA}^{2} - {AB}^{2} ) * {( cos θ 4 )}^{2} + \\ {( MG - ( \sqrt{{MB}^{2} + {OA}^{2} - {AB}^{2}} ) * sin θ 4 )}^{2}\end{matrix}} .$$

Based on the above data and signals, the dynamic signal generation means 108, the moving orientation prediction means 402 and the position prediction means 404 predict the next movement of the vehicle, especially the next movement of the trailer.

Set point C′ as the original point, C′ is generally the position of the backward vision camera, a horizontal two-dimensional coordinate is utilized.

GD is a distance from the middle point of the rear bridge of trailer to the right edge of the trailer. Point D is the right edge of the trailer.

GE is a distance from the middle point of the rear bridge of trailer to the left edge of the trailer. Point E is the left edge of the trailer.

GC′ is a distance from the original point C′ (the position of the backward camera) to the middle point of the rear bridge.

C′R is a distance from the original point C′ (the position of the backward camera) to the rear edge of the trailer. Point R is the rear edge of the trailer.

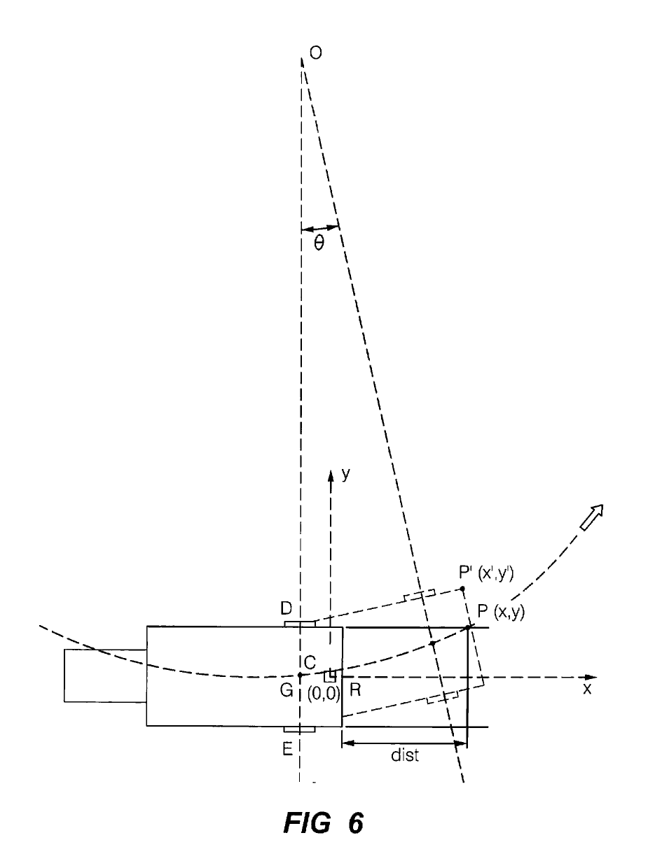

Since the backward vision camera may observe the scene within a predetermined distance behind the trailer. It is assumed that a point P is placed within the observation range of the backward vision camera, the coordinate of point P in the coordinate system with the original point C′ is P(x, y). The distance from the point P to the rear edge of the trailer is “dist”. As shown in FIG. 6, only the distance along axle x is considered in “dist”, the distance along axle y is not considered.

At a next time, point P moves to point P′, the coordinate of point P′ is P′(x′, y′). The trailer turns an angle θ, which means the angle of the line defined by the middle point of the rear bridge and point O. Angle θ may be computed as follows:

θ=dist/OG, “dist” means both the distance from point P to the rear edge of the trailer, and the length of the arc passed by point G. Angle θ may be computed by the formulation above.

P(x,y)=((dist+GC+CR),GD)

Then, the coordinate P′(x′, y′) of point P′ is:

P′(x′,y′)=((OG−GR)×sin θ+(GC+CR)×cos θ)−GC,OG×(1−cos θ)+(GC+CR)×sin θ+GR×cos θ).

Then the dynamic signal generation means 108 predicts the next position P′ of the reference point P.

After the moving orientation and the position are predicted based on the dynamic signals, the dynamic signal presentation means 110 presents the prediction based on the dynamic signals, so as to provide sufficient information to the driver.

As shown in FIG. 7, according to an embodiment, the dynamic signal presentation means 110 includes a video signal presentation means 702 and a dynamic signal rendering means 704. The video signal presentation means 702 presents video signals acquired by the video signal acquisition means 107. The video signal presentation means 702 may be implemented by a display. The dynamic signal rendering means 704 renders the dynamic signals generated by the dynamic signal generation means upon the video signals presented by the video signal presentation means.

According to an embodiment, the dynamic signal rendering means 704 includes an coordinate conversion means 740 for converting a real world coordinate to a pixel coordinate and a predicted line generation means 742 for generating predicted lines based on the moving orientation prediction signals and the position prediction signals.

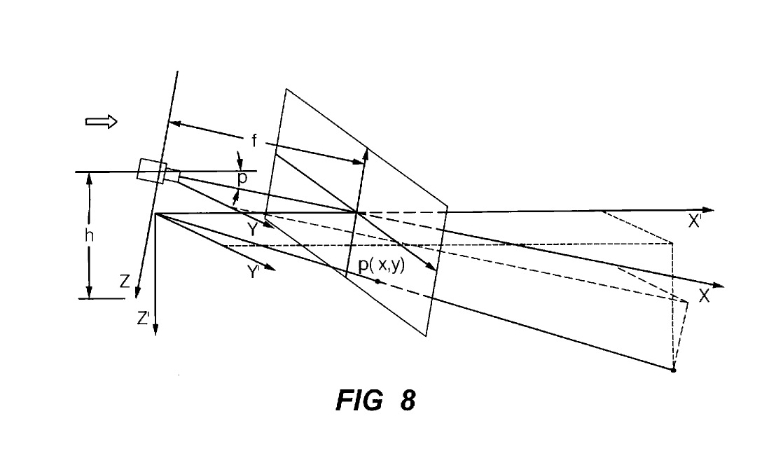

FIG. 8 illustrates a schematic view of presentation of a dynamic signal according to an embodiment of the present disclosure. The backward vision camera 800 (an implementation of the video signal acquisition means is raised to a height h with an inclined angle p. The coordinate used for prediction is a two-dimensional coordinate (x, y). The coordinate used by the backward vision camera is a three-dimensional coordinate (x′, y′, z′). It is assumed that the coordinate (x, y) used for prediction is set at a position with a distance f from the backward vision camera. A corresponding coordinate P(x, y, z) of the point P and a corresponding coordinate P′(x′, y′, z′) of the prediction position P′ in the three-dimensional coordinate may be obtained by existing conversion algorithm. The conversion algorithm shall be known in prior art and is not concerned by the present disclosure, the conversion algorithm is not described in detail here.

Therefore, the conversion from a real world coordinate to a pixel coordinate is accomplished. After obtaining the pixel coordinates of point P and the prediction point P′, the predicted lines may be rendered by using the pixel coordinates of point P′. Then a predicted moving track of the trailer may be rendered upon the video signals presented by the video signal presentation means.

The handling assistant apparatus for two-body connected vehicle may intuitively reflect the relationship between the driver's operation and the moving track of the trailer by rendering predicted lines. The accuracy of operation is raised and the possibility of accidents such as crash or scrape is reduced.

The previous description of the disclosed embodiments is provided to enable any person skilled in the art to make or use the present invention. Various modifications to these embodiments will be readily apparent to those skilled in the art and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A handling assistant apparatus for a two-body connected vehicle, applied to a two-body connected vehicle including a tractor and a trailer, the tractor and the trailer having different turn radius, the handling assistant apparatus comprising:
a static signal acquisition means for acquiring static signals of the tractor and the trailer;
a moving orientation signal acquisition means for acquiring moving orientation signals of the tractor and the trailer;
a video signal acquisition means for acquiring original video signals;
an angle acquisition means for acquiring an angle signal between the moving orientations of the tractor and the trailer;
a dynamic signal generation means for generating dynamic signals of the tractor and the trailer based on the original video signals, the static signals of the tractor and the trailer, the moving orientation signals of the tractor and the trailer and the angle signal between the moving orientations of the tractor and the trailer; and
a dynamic signal presentation means for presenting the dynamic signal generated by the dynamic signal generation means.

2. The apparatus of claim 1, wherein the static signal acquisition means comprises:
a length acquisition means for acquiring length signals of the tractor and the trailer;
a static turning radius acquisition means for acquiring minimum turning radius signals of the tractor and the trailer.

3. The apparatus of claim 1, wherein the angle acquisition means is mounted at the joint point of the tractor and the trailer.

4. The apparatus of claim 3, wherein the angle acquisition means is a Hall sensor.

5. The apparatus of claim 1, wherein the dynamic signal generation means comprises:
a moving orientation prediction means for generating moving orientation prediction signals of the tractor and the trailer based on the static signals, the moving orientation signals and the angle signal;
a position prediction means for generating position prediction signals of the tractor and the trailer based on the static signals, the moving orientation signals and the angle signal.

6. The apparatus of claim 5, wherein the dynamic signal presentation means comprises:
a video signal presentation means for presenting video signals acquired by the video signal acquisition means;
a dynamic signal rendering means for rendering the dynamic signals generated by the dynamic signal generation means upon the video signals presented by the video signal presentation means.

7. The apparatus of claim 6, wherein the dynamic signal presentation means comprises:
a coordinate conversion means for converting a real world coordinate to a pixel coordinate;
a predicted line generation means for generating predicted lines based on the moving orientation prediction signals and the position prediction signals.

8. The apparatus of claim 1, wherein the video signal acquisition means is a backward vision camera mounted on the rear of the trailer.

9. The apparatus of claim 8, wherein the backward vision camera is inclined at the top of the rear of the trailer.

10. A handling assistant apparatus for an articulated vehicle of the type including a tractor having a characteristic first minimum turn radius and a trailer having a second minimum turn radius, said handling assistant apparatus comprising:
static signal acquisition means operative to acquire static signals relating to parameters of the tractor and the trailer;
moving orientation signal acquisition means operative to acquire moving orientation signals of the tractor and the trailer;
video signal acquisition means including sensors having a fixed field of view external of said trailer operative to generate video signals as a function of images received from said sensors;
means operative to monitor the relative angle of articulation between the tractor and trailer and to generate an angle signal as a function thereof;
a controller operative to generate dynamic signals of the tractor and the trailer as a function of said video signals, said static signals of the tractor and the trailer, said moving orientation signals of the tractor and the trailer and the angle signal between the moving orientations of the tractor and the trailer; and
a dynamic signal presentation means operative to present the dynamic signal generated by the dynamic signal generation means a vehicle operator.

11. A handling assistant apparatus for an articulated vehicle of the type including a tractor having a characteristic first minimum turn radius and at least one trailer having a second minimum turn radius, said handling assistant apparatus comprising:
video signal acquisition means including sensors carried on said trailer having a fixed field of view external of said trailer operative to generate video signals as a function of images received from said sensors; and
a controller operative to receive signals defining the fixed geometry of the tractor and trailer, the dynamic attitude of the tractor and trailer, the instantaneous juxtaposition of the tractor and trailer, and the articulation angle therebetween, and generating an operator sensible signal depicting a moving track of the trailer as a function thereof.

12. The handling assistant apparatus of claim 11, wherein said tractor and trailer have different characteristic turn radii.

13. The handling assistant apparatus of claim 11, wherein said articulated vehicle comprises said tractor and a plurality of serially interconnected articulated trailers.

14. The handling assistant apparatus of claim 11, wherein said tractor characteristic first minimum turn radius is less than said trailer characteristic second minimum turn radius.
